(19) United States
(12) Patent Application Publication
(10) Pub. No.: US 2006/0186660 A1
(43) Pub. Date: Aug. 24, 2006

(54) Gap guard for a fender well

(76) Inventor: Stewart Cushman, Naples, FL (US)

Correspondence Address: Stewart Cushman, 5880 Hidden Oaks Lane, Naples, FL, 34119, US

(21) Appl. No.: 11/061,040

(22) Filed: Feb. 18, 2005

(51) Int. Cl. B62D 25/18

(52) U.S. Cl. 280/848

(57) ABSTRACT

A gap guard is constructed of a three-dimensional plastic material and is so designed to close the gap within a tire a rear tire well and the operating elements of the rear axle so as to hide the operating elements from view. The gap guard is to be fastened to the frame of the vehicle.

### CROSS REFERENCE TO RELATED APPLICATIONS

(none)

### STATEMENT REGARDING FED SPONSORED R & D

(none)

### BACKGROUND OF THE INVENTION

This invention is directed to vehicles, particularly to land vehicles and more particularly to trucks, vans and pick-up trucks. It is a known fact that the rear wheel wells are wide open to public view including the springs, the shock absorbers and the wheel axles. While this fact does not interfere with the performance of the vehicle, it is an unsightly view when observing the vehicle.

### BRIEF SUMMARY OF THE INVENTION

It is an object of the invention to provide a pre formed and three-dimensional gap guard to be installed within the fender well and between the operating parts of the rear axle of the vehicle to hide the view of theses operating parts. It may be considered to be a cosmetic treatment of the rear fender well. The gap guard is a single piece of a plastic material and is pre-formed to snugly fit within the existing wheel well and may be fastened to the existing vehicle frame so that it moves with the wheel frame but not with the moving axle and other moving parts while the vehicle is in motion.

### BRIEF DESCRIPTION OF THE DRAWINGS

FIG. 1 shows a conventional wheel well of a pick-up truck or a van, for example;

FIG. 2 shows a perspective view of the inventive gap guard as it is installed in a wheel well;

FIG. 3 is a front view of the inventive gap guard hiding the operating parts of the rear axle;

FIG. 4 is a perspective view of a particular gap guard;

FIG. 5 is a perspective view of a different gap guard to be used in a different vehicle;

FIG. 6 is still a different perspective view of a gap guard for a different vehicle having dual rear wheels.

### DETAILED DESCRIPTION OF THE INVENTION

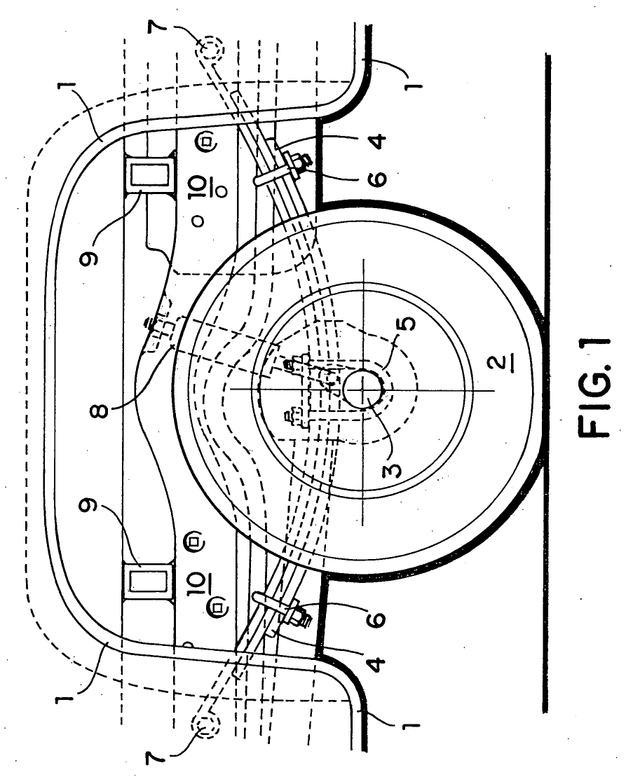

FIG. 1 illustrates a wheel well of a standard pick-up or van assembly and showing the standard operating elements such as the outline of the fender 1. The outline includes the tire 1 with its axle 3. Further, there is shown a spring assembly 4 which induces the axle 3 to move up and down according to the road conditions. The axle 3 is fastened to the springs 4 by way of the U-shaped bolt 5 as is well known. In addition there is located a shock absorber 8 which is also well known. The wheel well also has and shows the basic vehicle assembly frame having cross bars 9. The spring assemblies are fastened to the vehicle assembly 10 at 7 so as to spring the basic vehicle assembly relative to the axle assembly 3.

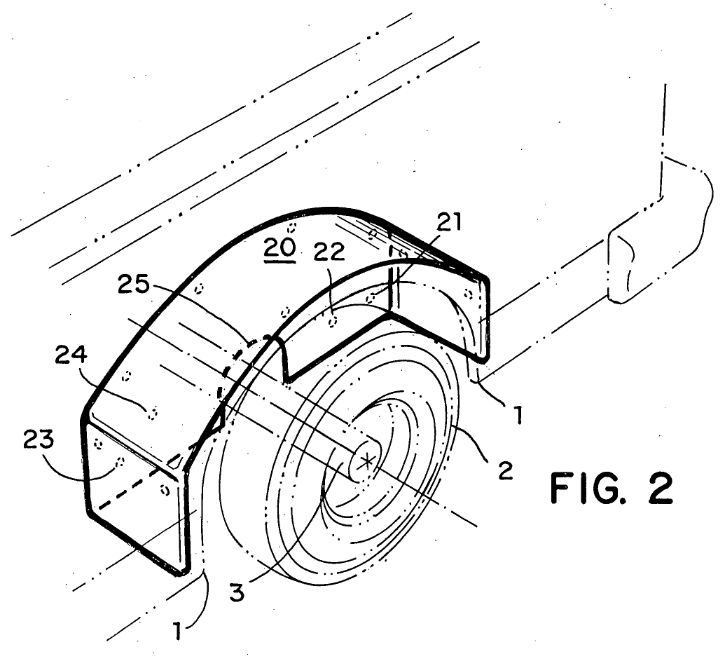

FIG. 2 exhibits the basic rear wheel assembly as it is covered by the basic gap guard 20 to conceal all of the operating elements of the rear axle assembly. The gap guard 20 consists of a molded pre-form 20 having a recess 25 for the free movement of the axle 3 so as not to interfere with the free movement of the axle 3. The pre-molded gap guard 20 should be attached to the basic frame assembly 10 (FIG. 1) by way of the fasteners 21-24 so as to be rigidly attached to the basic vehicle frame 10.

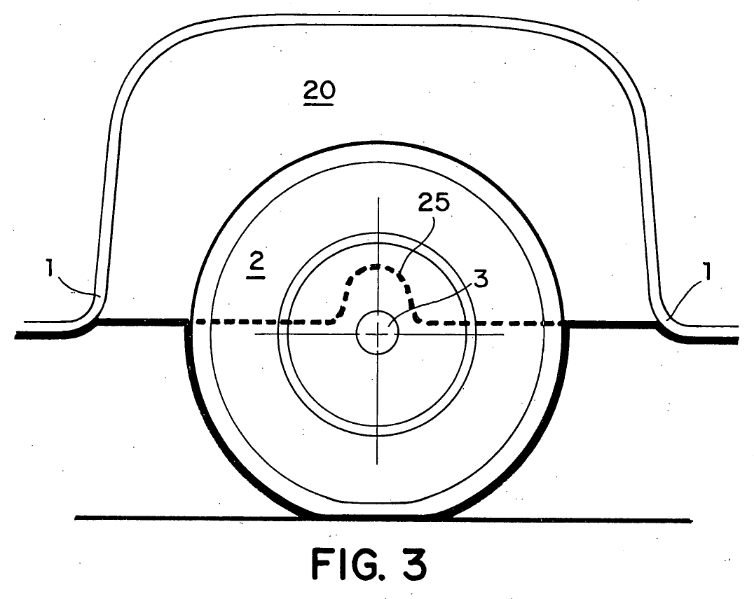

FIG. 3 is a side view of the gap guard 20 installed in the wheel well of a vehicle described above. As can be seen in this Fig., none of the operating elements of the vehicle can be seen in this Fig. because they are hidden behind the gap guard 20 of the inventive concept.

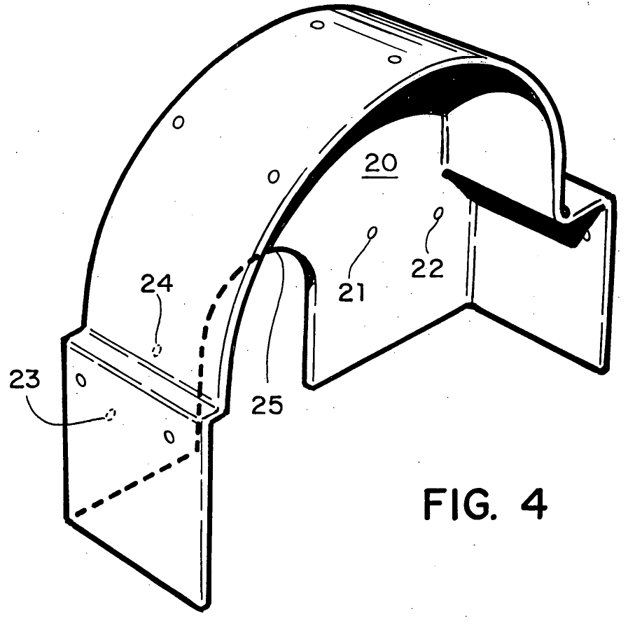

FIG. 4 is a perspective view of a gap guard 20 as it is to be applied to a Ford rear wheel assembly (not shown). The gap guard 20 again shows the fastening elements 21-24 that will fasten the gap guard to the basic frame of the vehicle.

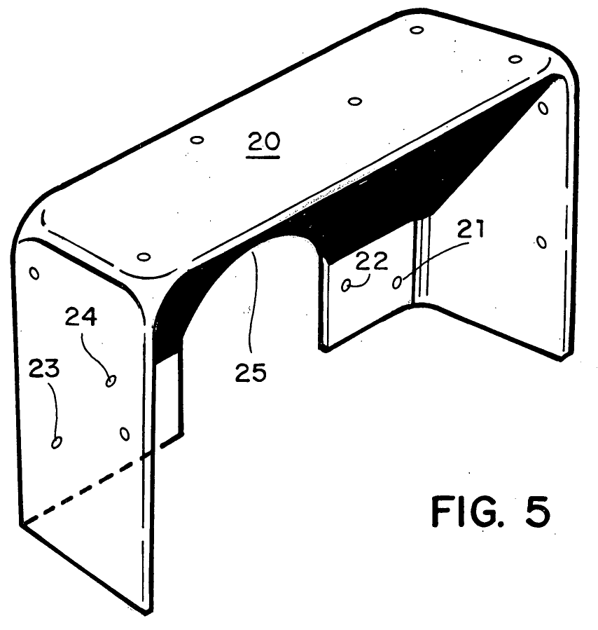

FIG. 5 shows a perspective view of a gap guard to be applied to a Chevvy rear axle which may be different from other vehicles but it shows the gap guard applied to a different vehicle.

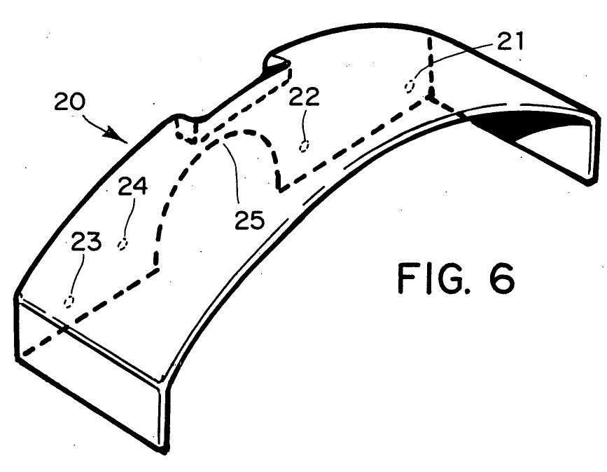

FIG. 6 shows a perspective view of yet a different gap guard which can be applied to a dual wheel rear end construction such as a rear end Dodge wheel assembly

What I claim is:

1. A gap guard to be installed in a rear wheel well assembly of a vehicle, said gap guard comprising a structured 3-dimensional structure, said gap guard being dimensioned to fill in the gap between the fender of said vehicle and the operating elements of said rear end to hide said elements from view.

2. The gap guard of claim 1, wherein said gap guard is made of a plastic material.

3. The gap guard of claim 1, wherein said gap guard completely surrounds a tire above the axle of said rear end.

4. The gap guard of claim 1, wherein said gap guard is constructed in such a way to cover at least two adjacent rear tires of a vehicle.

5. The gap guard of claim 1 including means for fastening said gap guard on a frame of said vehicle.
